(19) United States
(12) Patent Application Publication
(10) Pub. No.: US 2012/0182007 A1
(43) Pub. Date: Jul. 19, 2012

(54) FLOW CHAMBER HAVING A GMR SENSOR AND A CELL GUIDING DEVICE

(76) Inventors: Ludwig Bär, Erlangen (DE); Helmut Eckert, Rottenbach (DE); Oliver Hayden, Herzogenaurach (DE); Sandro Francesco Tedde, Erlangen (DE); Michael Vieth, Mohrendorf (DE); Roland Weiss, Erlangen (DE)

(21) Appl. No.: 13/499,603

(22) PCT Filed: Aug. 17, 2010
(86) PCT No.: PCT/EP2010/061944

§ 371 Date: Mar. 30, 2012

(30) Foreign Application Priority Data
Sep. 30, 2009 (DE) 10 2009 047 793.4

(51) Int. Cl. G01N 27/74

(52) U.S. Cl. 324/204

(57) ABSTRACT

Magnetically labeled cells in a flow chamber cytometer are detected by a GMR sensor. The flow chamber includes a cell guiding device having at least one first and one second magnetic or magnetizable flow strip. The flow strips, which serve to guide the flowing cells across the sensor in a target-oriented manner, are mounted at a distance from each other such that a magnetic field B_{F} is produced between them. The GMR sensor is arranged in the region of the magnetic field B_{F} between the flow strips such that the magnetic field B_{F} can be used as the operating magnetic field B_{GMR} of the GMR sensor. In this way, the need for additional magnets for operating the GMR sensor is eliminated.

### CROSS REFERENCE TO RELATED APPLICATIONS

This application is the U.S. national stage of International Application No. PCT/EP2010/061944, filed Aug. 17, 2010 and claims the benefit thereof. The International Application claims the benefit of German Application No. 102009047793.4 filed on Sep. 30, 2009. Both applications are incorporated by reference herein in their entirety.

### BACKGROUND

Described below is a flow chamber with a cell guiding device and a GMR sensor for detecting magnetically-labeled cells.

In a magnetic flow cytometer, labeled cells can be detected with the help of special sensors. For this purpose, a medium which has both unlabeled and also labeled cells is fed through a micro-fluid duct in a flow chamber, on the inner surface of which is positioned the sensor. The labeled cells, in particular, ideally pass very close to the surface of the sensor and are detected by the latter.

For this purpose use is made, for example, of GMR (giant magneto-resistance) sensors. As is known, the way in which a GMR sensor functions is based on the GMR effect, in which variations in an external magnetic field produce comparatively large changes in the electrical resistance of the sensor or the GMR structure which it contains. In other words, from a measurement of the electrical resistance of the GMR sensor it is possible to reach conclusions about the magnetic field in whose region of influence the GMR is located.

In typical applications of GMR sensors, an external operational magnet field B_{GMR} is first created selectively. As soon as a magnetic body comes within range of the GMR sensor in this operational magnetic field B_{GMR}, or moves through the field, the magnetic field changes at the site of the sensor with the consequence that the electrical resistance of the sensor also changes measurably. I.e. with the help of the GMR sensor it is possible to detect or register the presence of the magnetic body.

In the situation where such a GMR sensor is used in a flow chamber of a flow cytometer, magnetically labeled cells can be detected using the sensor, whereby the measurement principle is based on the effect described above: a magnetically-labeled cell which is passing the GMR sensor affects the operational magnetic field B_{GMR} at the site of the sensor, so that the presence of the cell can be demonstrated via a measurement of the electrical resistance of the sensor. However, a basic prerequisite which is necessary for the functioning of the GMR sensor is the presence of the external operational magnetic field B_{GMR}. Associated with this is the need to provide an appropriate magnet, for example a permanent magnet or a current-carrying coil. However, this is disadvantageous due to the limited space available, for example, and in the case of a current-carrying coil due to the required circuitry and power supply for the coil.

### SUMMARY

It is therefore desirable to make possible low cost cell detection using a GMR sensor.

A flow chamber, through which a medium having magnetically-labeled cells can flow, has at least one GMR sensor, positioned on an inner surface of the flow chamber, for the detection of cells, together with a cell guiding device with at least one first and one second magnetic or magnetizable flow strip. The flow strips are arranged at such a distance apart that a magnetic field B_{F} is created between them. The GMR sensor is arranged in the region of the magnetic field B_{F} between the flow strips in such a way that the magnetic field B_{F} from the flow strips can be used as the operational magnetic field B_{GMR} of the GMR sensor.

It is accordingly possible in an advantageous way to dispense with any additional magnet for operating the GMR sensor.

In an advantageous embodiment of the flow chamber, the first flow strip is positioned upstream of the sensor, when looking in the forward direction of flow, and is arranged and constructed in such a way that it guides over the GMR sensor the magnetically-labeled cells which are flowing in the forward flow direction.

In another advantageous embodiment of the flow chamber, the second flow strip is positioned downstream of the GMR sensor, when looking in the forward direction of flow, and is arranged and constructed in such a way that it guides over the GMR sensor the magnetically-labeled cells which are flowing in the backflow direction.

These embodiments ensure that the majority of the magnetically-labeled cells can actually be detected by the GMR sensor.

In the method described below for operating a GMR sensor for cell detection in a flow chamber of a flow cytometer, through which flows a medium with magnetically-labeled cells and which has a cell guiding device with at least one first and one second magnetic or magnetizable flow strip, the flow strips are arranged at such a distance apart that a magnetic field B_{F} is created between them. The GMR sensor is arranged in the region of the magnetic field B_{F} between the flow strips. The magnetic field B_{F} between the flow strips can then be used as the operational magnetic field B_{GMR} of the GMR sensor.

In a development of the method, the first flow strip guides over the GMR sensor magnetically-labeled cells which are flowing in the forward flow direction.

In another development of the method, the second flow strip guides over the GMR sensor magnetically-labeled cells which are flowing in the backflow direction.

### BRIEF DESCRIPTION OF THE DRAWINGS

These and other aspects and advantages will become more apparent and more readily appreciated from the following description of the exemplary embodiment, taken in conjunction with the accompanying drawings of which:

FIG. 1 is a cross-sectional view of flow chamber,

FIG. 2 is a plan view of a micro-fluid duct in the flow chamber,

FIG. 3 is a side view of a cell guiding device in a GMR sensor,

FIG. 4 is a plan view of a micro-fluid duct in another embodiment of the flow chamber.

### DETAILED DESCRIPTION OF THE PREFERRED EMBODIMENT

In these figures, areas, components, assemblies, etc. which are respectively identical or correspond to each other are labeled with the same reference numbers.

FIG. 1 shows a cross-sectional view of a flow chamber 10 of a flow cytometer. A medium 70, which contains the magnetically-labeled cells 20 which are to be detected together with unlabeled cells 30, passes in the direction of forward flow 130 through an opening 40 into the flow chamber 10. The medium 70 flows through a micro-fluid duct 11 in the chamber 10 and, after the detection, leaves this again through another opening 50. The magnetically-labeled cells 20 are detected with the help of a GMR sensor 60. When the magnetic cells 20 pass the GMR sensor 60, they influence the operational magnetic field B_{GMR} prevailing at the site of the sensor. This is registered by the GMR sensor 60 and used for the purpose of detection.

The flow chamber 10 has a cell guiding device 120. The purpose of this device 120 is to enable the magnetically-labeled cells 20, which at the entrance 40 to the flow chamber 10 are still randomly distributed in the medium 70, to be guided selectively over the sensor 60, i.e. at least within its range, ideally centrally and immediately above the surface of the sensor 60. A consequence of this is that a significantly greater number of cells 20 can be detected, because significantly fewer cells flow, for example, past the side of the sensor 60. It is then no longer a matter of chance whether a labeled cell 20 comes within range of the sensor 60 and can be detected. Various forms of embodiment of such a cell guiding device are described in the parallel German patent application “Durchflusskammer mit Zellleiteinrichtung” [Flow chamber with cell guiding device].

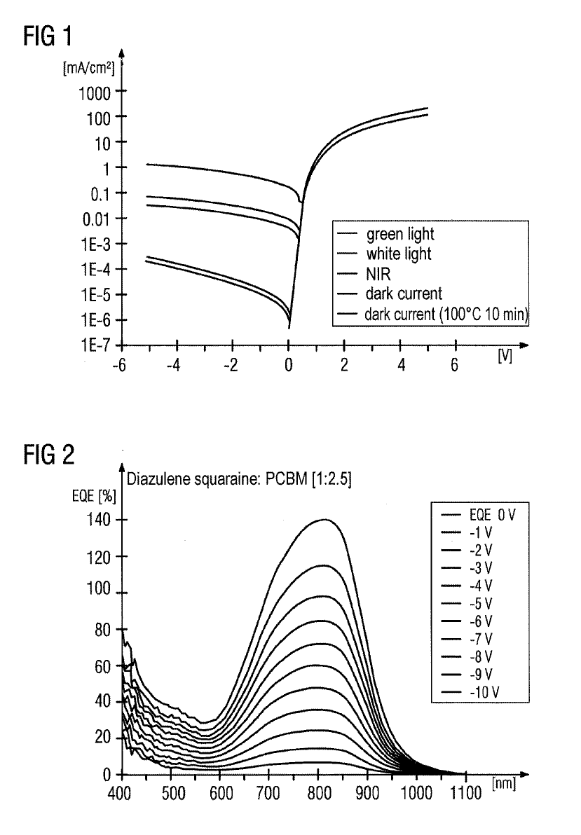

FIG. 2 shows a plan view of the interior of a flow chamber 10, where for the sake of clarity the unlabeled cells 30 are not shown. For the same reason, only a few of the cells 20 have, by way of example, been given reference marks. In this exemplary embodiment, the cell guiding device 120 has two flow strips 121, 122 where, looking in the direction of forward flow 130, the first flow strip 121 is arranged in front of the GMR sensor 60 and the second flow strip 122 behind the sensor 60, so that the first flow strip 121, the GMR sensor 60 and the second flow strip 122 lie on a line. Thus, after detection, the cells 20 which pass the sensor 60 are also guided on intended paths. The flow strips 121, 122 are aligned in the direction of forward flow 130 of the medium.

The interaction between the magnetic cells 20 and the magnetic flow strips 121 has the effect that, as they flow past the strip 121 in the medium 70, the cells 20 lose their random distribution and in time arrange themselves over the strip 121. At its entry end, the first flow strip 121 has a wider region 121/1, with the help of which the labeled cells 121 are guided towards the narrower region 121/2 (the term “wide” here refers to the direction perpendicular to the direction of flow 130, i.e. to the y-direction). In the extreme case, the width of the strip 121 in the region 121/1 can correspond to the width of the micro-fluid duct 11. The width of the flow strip 121 in the narrower region 121/2, at its rear when looking in the forward direction of flow 130, can essentially be determined by the diameter of the cells 20, but in general is less than the width of the sensor 60. The shape of the flow strip shown here is to be understood as merely an example. Other shapes are of course also conceivable, depending on the desired effect.

With the help of the cell guiding device 120, the labeled cells 20 which are ordered on the first flow strip 121 are guided selectively over the GMR sensor 60. Apart from a few exceptions, which have not been captured by the magnetic flow strips 121 and hence are not guided to the sensors 60, it may be assumed that a majority of the labeled cells 20 in the medium 70 come within range of the GMR sensors 60, so that with the arrangement shown a high yield can be achieved which manifests itself, for example, in a shorter measurement time for constant statistics, or in improved statistics for a constant measurement time.

The flow strips 121, 122 may be formed of a magnetic or magnetizable material, for example of nickel. As already noted for the first flow strip 121, the width of the second flow strip 122 can also essentially be determined by the diameter of the cells 20, but as a rule is less than the width of the sensor 60. Typically, the strips 121, 122 are up to 10 μm wide and 100-500 nm high (z-direction). Heights of the order of magnitude of 1 μm are also conceivable. The micro-fluid duct 11 is typically 100-400 μm wide, 100 μm high and about 1 mm long (x-direction). The GMR sensors 60 are about 25-30 μm wide.

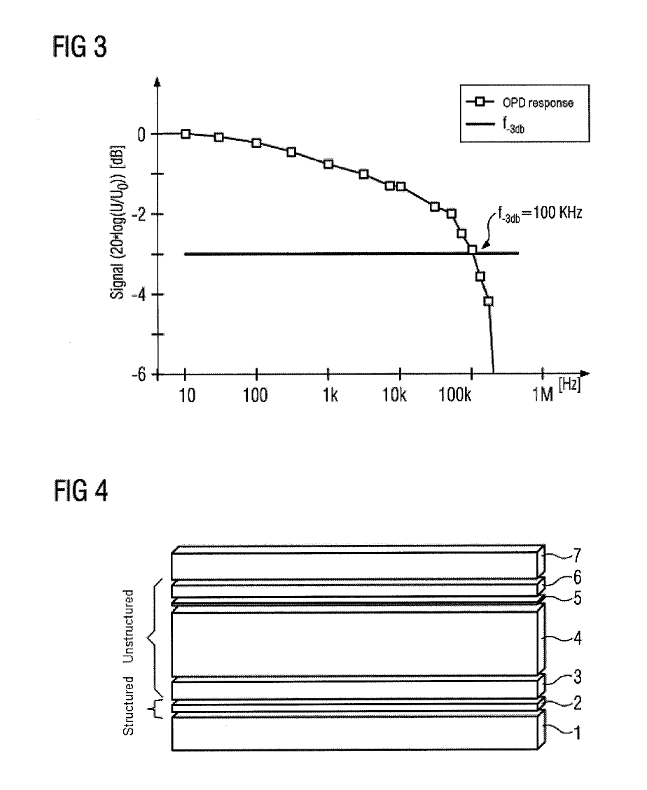

As a result, it is possible to dispense with any additional magnet for creating the operational magnetic field B_{GMR} which is necessary for operating the GMR sensors 60, because the arrangement of the flow strips relative to the GMR sensor 60 results in a magnetic field B_{F}, which can be used as the operational magnetic field B_{GMR}, being created by the magnetic flow strips 121, 122. This is shown in FIG. 3.

FIG. 3 shows a side view or cross-section through the first flow strip 121, the GMR sensor 60 and the second flow strip 122.

FIG. 3A shows the situation at a first point in time t1, at which the magnetically-labeled cell 20 is still so far away from the GMR sensor 60 that the magnetic field B_{F} created by the two flow strips 121, 122 which surround the sensor 60, the field lines of which point in the example from the first flow strip 121 to the second 122, is not affected by the cell 20.

At a point in time t2, which is shown in FIG. 3B, the magnetically-labeled cell 20 has reached the GMR sensor 60. The magnetic field B_{F}, which is created by the flow strips 121, 122 in the region of the sensor 60, is altered by the cell 20, so that the GMR sensor 60 can detect the cell 20 due to the GMR effect described in the introduction. At the site of the GMR sensor 60, a high field difference is produced between the ends of the magnetic strips 121, 122 and due to the magnetically-labeled cell 20 quasi short-circuiting the flow strips 121, 122. The consequence is a large usable step signal, even though no additional magnet is being used for the creation of the external magnetic field B.

Finally, FIG. 3C shows a third point in time t3, at which the cells 20 have now left the GMR sensor 60 again. The magnetic field B_{F} between the flow strips 121, 122 has readjusted itself to how it was shown in FIG. 3A.

Hence, the magnetic field B_{F}, which is in any case present at the gap between the first and second flow strips 121, 122 of the cell guiding device 120, is used to provide the operational magnetic field B_{GMR} required for the operation of the GMR sensor 60, i.e. B_{GMR}=B_{F}. This magnetic field is distorted during the presence of a magnetically-labeled cell 20, with the effect that the electrical resistance of the GMR sensor 60 changes measurably.

It is of course conceivable in principle to provide not merely one single track, as shown in FIG. 2, formed by the first and second flow strips 121, 122 and the sensor 60, but rather a plurality of such tracks together with an appropriate number of sensors, which will then ideally be arranged parallel to each other. For each track, a magnetic field B_{F} forms in each case between the first and second flow strips which are arranged respectively before and after the GMR sensor concerned, and this can be used as described above as the operational magnetic field B_{GMR} of the associated GMR sensor. A corresponding flow chamber is shown in FIG. 4.

In the method of operating the flow chamber, for the purpose of detecting the magnetically-labeled cells 20 in the medium 70 which is flowing through the flow chamber 10 of the flow cytometer, using the GMR sensor 60, the labeled cells 20 in the flow are, as already indicated above, guided over the GMR sensor 60 by the first magnetic or magnetizable flow strip 121 of the cell guiding device 120. The second flow strip 122 is advantageously used, for example, when the medium 70 and with it the magnetically-labeled cells 20 are guided over the sensor 60 not only in the forward flow direction 130 (positive x-direction), but alternately in the forward flow direction 130 and in the backflow direction 130′ (negative x-direction, cf. FIG. 2). The cells 20 accordingly brush repeatedly over the sensors 60. This can be used, for example, to improve the statistics.

The cells 20 passing the sensor 60 are in general already ordered, i.e. no longer randomly distributed. The second flow strip 122 thus serves essentially to guide the cells 20 over the sensor 60, whereas the first flow strip 121, in particular its wider region 121/1 has in addition the function of collecting the cells 20, which are initially randomly distributed, and guiding them onto the narrower region 121/2.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A flow chamber with an inner surface, through which can flow a medium having magnetically-labeled cells, comprising:
at least one giant magneto-resistance sensor positioned on the inner surface of the flow chamber, to detect the magnetically-labeled cells; and
a cell guiding device having first and second flow strips that are at least one of magnetic and magnetizable, the first and second flow strips arranged a predetermined distance apart to create a magnetic field therebetween, said at least one giant magneto-resistance sensor disposed in a region of the magnetic field between the flow strips so that the magnetic field from the flow strips provides an operational magnetic field of the giant magneto-resistance sensor.

8. The flow chamber as claimed in claim 7, wherein the first flow strip is positioned upstream of the giant magneto-resistance sensor and guides the magnetically-labeled cells moving in a forward direction of flow over the giant magneto-resistance sensor.

9. The flow chamber as claimed in claim 8, wherein the second flow strip is positioned downstream of the giant magneto-resistance sensor and guides the magnetically-labeled cells moving in a backflow direction over the giant magneto-resistance sensor.

10. A method for operating a giant magneto-resistance sensor to detect cells in a flow chamber of a flow cytometer through which a medium with magnetically-labeled cells is flowing, comprising:
arranging, as a cell guiding device, first and second flow strips, that are at least one of magnetic and magnetizable, a predetermined distance apart to create a magnetic field therebetween;
positioning the giant magneto-resistance sensor in a region of the magnetic field between the flow strips; and
using the magnetic field between the flow strips as an operational magnetic field of the giant magneto-resistance sensor.

11. The method as claimed in claim 10, wherein said using comprises guiding, by the first flow strip, the magnetically-labeled cells moving in a forward flow direction over the giant magneto-resistance sensor.

12. The method as claimed in claim 11, wherein said using further comprises guiding, by the second flow strip, the magnetically-labeled cells moving in a backflow direction over the giant magneto-resistance sensor.
